(19) United States
(12) Patent Application Publication
(10) Pub. No.: US 2025/0266590 A1
(43) Pub. Date: Aug. 21, 2025

(54) SENSOR AND METHOD FOR DETERMINING ADVERSE THERMAL EVENT IN BATTERY CELL

(71) Applicant: Caterpillar Inc., Peoria, IL (US)

(72) Inventors: Siddartha Saikia, Chennai (IN); Luvkush Kumar, Mathura (IN)

(73) Assignee: Caterpillar Inc., Peoria, IL (US)

(21) Appl. No.: 18/442,140

(22) Filed: Feb. 15, 2024

(51) Int. Cl. H01M 50/581; H01M 10/04; H01M 10/48

(52) U.S. Cl. CPC H01M 50/581; H01M 10/486; H01M 10/0481; H01M 2200/103

(57) ABSTRACT

A battery system includes a battery cell including a housing. The housing includes a plurality of walls that define an outer surface of the housing. The battery system also includes a sensor coupled to the outer surface to determine an adverse thermal event in the cell. The sensor includes a deformable element made of a shape-memory material (SMM) that has a pre-stressed shape. The deformable element is adapted to deform to a memorized shape from the pre-stressed shape in response to an operating temperature of the cell exceeding a predefined temperature threshold for the cell. The memorized shape of the deformable element is different from the pre-stressed shape of the deformable element. A deformity of the deformable element to the memorized shape is indicative of the adverse thermal event in the cell.

### TECHNICAL FIELD

The present disclosure relates to a battery system including a battery cell, a sensor for determining an adverse thermal event in the battery cell, and a method for determining the adverse thermal event in the battery cell.

### BACKGROUND

Battery systems are used in various applications such as in energy storage systems, work machines, or electric vehicles to store and provide operating power. Each of these battery systems have multiple battery cells therein, arranged either in parallel, in series or in combinations thereof. These cells may be sensitive to temperature. It may be preferable to operate these cells below their maximum operating temperature. Above the maximum operating temperature for a particular cell, a performance of the cell may deteriorate or the cell may altogether fail. For example, under heavy load conditions, an increase in current demand from the cells may lead to heating of the cells. If a temperature of the cell exceeds the maximum operating temperature, an adverse thermal event may occur in the cell, that, in turn, may lead to a failure of the cell and consequently, the battery system. These adverse thermal events may include at least one of an overheating event, a fire originating from the battery cell and a thermal runaway event.

Conventional cells have a separator that is configured to disable the corresponding cell when the temperature of the cell exceeds the maximum operating temperature. The separator may allow exchange of ions between a cathode and an anode of the cell, via the separator at temperatures below the maximum operating temperature and may prevent exchange of ions through the separator at temperatures above the maximum operating temperature, thereby preventing adverse thermal events in most cases. For example, the separator may melt at the maximum operating temperature, permanently disabling the cell. An example of such a separator is a tri-layer cell separator comprising a layer of polyethylene between two layers of polypropylene. In an event that a cell undergoes such a failure, a service technician would be able to identify and replace such disabled cells.

It is also known to identify disabled battery cells by measuring an impedance of the cells. However, if these cells are disposed in parallel, it may be challenging to measure the impedance of the individual cells. Moreover, although it is possible to measure impedance of individual cells that are connected in series, the process of repeating the measurement process for each cell can be time consuming. Often batteries are packaged in such a way that opening a battery pack for impedance measurements may be a time consuming exercise.

As an alternative to measuring individual impedances of cells connected in series, it is known to monitor the temperature of the cell to determine whether the maximum operating temperature at which the separator melts has exceeded. This may be achieved by disposing a thermistor in each cell. However, incorporating a thermistor in each cell may be expensive and may increase overall costs associated with manufacturing the battery system.

PCT Publication 2023/279089, hereinafter referred to as ‘the '089 reference’, describes materials and systems to manage thermal runaway issues in a battery module. In the '089 reference, the battery module includes battery cells separated by spacer elements. To mitigate thermal runaway issues, spacer elements may be extended to the interior surface of the enclosure. A seal is formed between the spacer elements and the interior wall to form a thermal barrier between adjacent battery cells.

However, the spacer elements described in the '089 reference includes a heat activated material made from a shape memory element that flips upward when triggered by heat thereby blocking heat, fire, and other materials that are released during thermal runaway events in order to prevent thermal propagation between cells. Thus, the shape memory element is used to contain or mitigate thermal propagation in battery cells. However, the shape memory element described in the '089 reference directly mitigates risk associated with continued operation of the battery cell but, however, does so without providing an indication as to the occurrence of the adverse thermal event itself. Further, typically very high levels of current flow through a battery terminal, which makes it necessary for a direct current bus to be laser welded to the battery terminal to prevent arching. It may be challenging for a disclosed in the '089 reference to maintain necessary contact without forming arc in case of high levels of current.

### SUMMARY

In an aspect, a battery system is provided. The battery system includes a battery cell. The battery cell includes a housing. The housing includes a plurality of walls that define an outer surface of the housing. The battery system also includes a sensor coupled to the outer surface of the housing and configured to determine an adverse thermal event in the battery cell. The sensor includes a deformable element made of a shape-memory material (SMM) and has a pre-stressed shape. The deformable element is adapted to deform to a memorized shape from the pre-stressed shape in response to an operating temperature of the battery cell exceeding a predefined temperature threshold for the battery cell. The memorized shape of the deformable element is different from the pre-stressed shape of the deformable element. A deformity of the deformable element to the memorized shape is indicative of the adverse thermal event in the battery cell.

In another aspect, a sensor for determining an adverse thermal event in a battery cell is provided. The sensor includes a deformable element made of a shape-memory material (SMM) and has a pre-stressed shape. The deformable element is adapted to deform to a memorized shape from the pre-stressed shape in response to an operating temperature of the battery cell exceeding a predefined temperature threshold for the battery cell. The memorized shape of the deformable element is different from the pre-stressed shape of the deformable element. A deformity of the deformable element to the memorized shape is indicative of an adverse thermal event in the battery cell.

In yet another aspect, a method for determining an adverse thermal event in a battery cell is provided. The method includes coupling a sensor, including a deformable element made of a shape-memory material (SMM), to an outer surface of a housing of the battery cell. The deformable element has a pre-stressed shape. The method also includes deforming the deformable element to a memorized shape from the pre-stressed shape when an operating temperature of the battery cell exceeds a predefined temperature threshold for the battery cell. The memorized shape of the deformable element is different from the pre-stressed shape of the deformable element. The method further includes indicating the adverse thermal event in the battery cell based on a deformity of the deformable element to the memorized shape.

Other features and aspects of this disclosure will be apparent from the following description and the accompanying drawings.

### BRIEF DESCRIPTION OF THE DRAWINGS

FIG. 1 is a schematic view of a battery system including a battery cell and a sensor, according to an embodiment of the present disclosure;

FIG. 2 is a schematic view of the battery system of FIG. 1, wherein a deformable element of the sensor is in a pre-stressed shape;

FIG. 3 is a schematic view illustrating the deformable element of the sensor of FIG. 2 in a memorized shape;

FIG. 4 is a schematic view illustrating an array of sensors to identify adverse thermal events in corresponding battery cells in a battery system, according to an embodiment of the present disclosure; and

FIG. 5 is a flowchart of a method for determining an adverse thermal event in the battery cell, according to an embodiment of the present disclosure.

### DETAILED DESCRIPTION

Wherever possible, the same reference numbers will be used throughout the drawings to refer to the same or like parts.

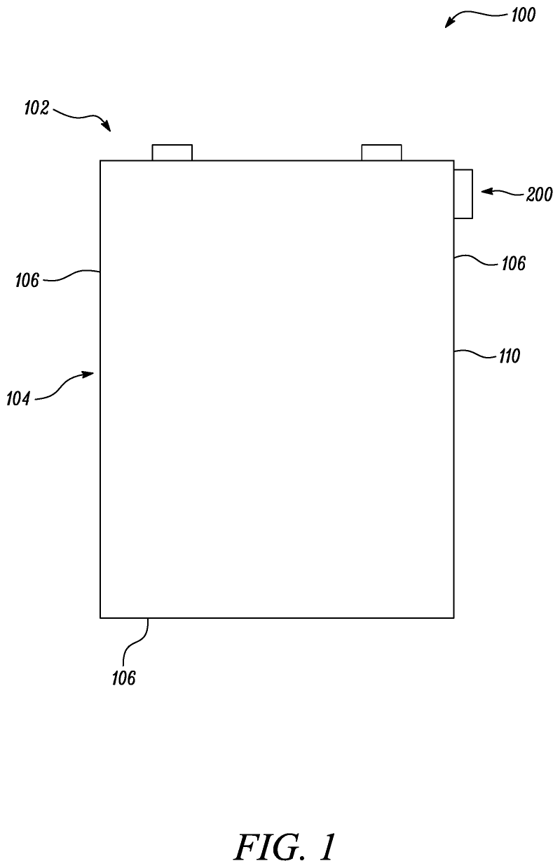

Referring to FIG. 1, a schematic view of a portion of an exemplary battery system 100 is illustrated. The battery system 100 is typically used to store electrical power and distribute the stored electrical power at a desired power output and a desired voltage output. In an example, the battery system 100 may be used in energy storage systems. In another example, the battery system 100 may supply electrical power to a moving machine or a stationary machine, such as, a work or construction machine.

The battery system 100 includes a battery cell 102. In this disclosure, the battery cell 102 will be hereinafter interchangeably referred to as ‘cell 102’. In the illustrated embodiment of FIG. 1, the cell 102 is embodied as a lithium-ion battery cell. Alternatively, the cell 102 may include any other type of battery cell, such as, a lead-acid battery cell, a nickel metal hydride battery cell, and so on. Further, for illustrative purposes, the battery system 100 is shown to have a single cell 102 in FIG. 1. However, the battery system 100 may include multiple battery cells, similar to the cell 102, that may be arranged in series, in parallel, or in a combination of parallel and series, without limiting the scope of the present disclosure.

The cell 102 includes a housing 104. The housing 104 includes a number of walls 106 that define an outer surface 110 of the housing 104. Further, an enclosed space (not shown) is defined within the number of walls 106. The cell 102 also includes a cell unit (not shown) disposed within the enclosed space of the housing 104. The cell unit may include an anode, a cathode, and an electrolyte disposed between the anode and the cathode. In some examples, the anode may be made of graphite into which lithium can be incorporated. The cathode may be made of lithium cobalt (III) oxide (LiCoO2), lithium-nickel-manganese-cobalt oxides, and other materials known to a person having ordinary skill in the art. The electrolyte may include a lithium salt dissolved in a specific solvent for example, ethylene carbonate (EC), diethyl carbonate (DEC), dimethyl carbonate (DMC), propylene carbonate (PC), or the like. In an example, during discharging of the cell 102, lithium may be oxidized at the anode and may be migrated through the electrolyte towards the cathode. Conversely, during charging of the cell 102, the reverse process may take place.

In some examples, the cell 102 may be designed to trigger an endothermic reaction in the active material, for example, in the anode, the cathode, or the electrolyte arranged between them, in response to an undesired adverse thermal event. It should be noted that construction and composition details of the cell 102 as mentioned herein are exemplary in nature, and the cell 102 may include any other construction and cell composition.

The battery system 100 also includes a sensor 200 coupled to the outer surface 110 of the housing 104 of the cell 102. In use, the sensor 200 may be placed adjacent to a region of the cell 102 that is visible in an event that the battery system 100 is opened. For example, the sensor 200 may be placed adjacent to a top rim of the cell 102. The sensor 200 may be placed such that it may be easy to access.

The sensor 200 determines an adverse thermal event in the cell 102. The adverse thermal event in the cell 102 may include an overheating event, a fire originating from the cell 102, or a thermal runaway event, without any limitations. The thermal runaway event is a phenomenon in which a particular battery cell enters a self-heating state and can be an issue if a rechargeable battery cell is handled improperly, or if there are defects or faults in the battery cell.

In some examples, the cell 102 may be designed to operate in a temperature range of 60 to 75° C. As an example, adverse thermal events, such as the thermal runaway event, may occur in the cell 102 operating in a temperature range of 85 to 110° C. However, it is to be noted that values of an operating temperature of the cell 102 as disclosed herein are merely exemplary in nature. The specific operating temperatures of each cell 102 may vary based on various factors including, but not limited to, battery composition and cell chemistry.

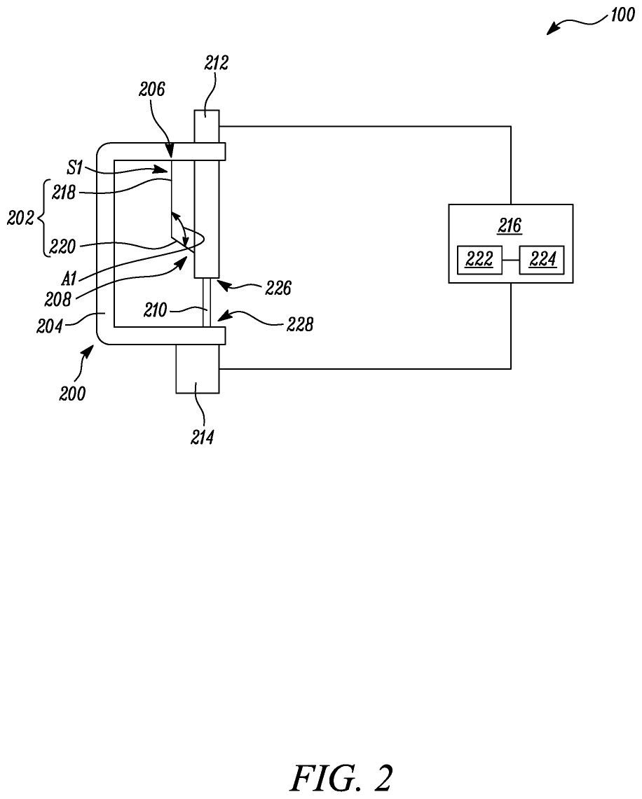

Referring to FIG. 2, a schematic of the battery system 100 including the sensor 200 is illustrated. The sensor 200 includes a deformable element 202. The deformable element 202 is a heat sensitive element herein. The deformable element 202 is made of a shape-memory material (SMM) and has a pre-stressed shape S1. The SMM of the deformable element 202 is a shape-memory alloy (SMA). The shape-memory alloy may be an alloy made of one or more metallic materials or one or more polymers. In some examples, the SMA may include copper-aluminum-nickel alloy, nickel-titanium (NiTi) alloy, or an alloy based on zinc, copper, gold, and iron. In other examples, the SMM of the deformable element 202 is a shape-memory polymer. The shape-memory polymer may include thermoplastic or thermoset (covalently cross-linked) polymers, for example. It should be noted that the present disclosure is not limited by a type of the SMM.

In an embodiment, the deformable element 202 may be a thin film made of the SMM. Further, the deformable element 202 may be a strip, a membrane, or a micro machined element made of the SMM. In some examples, the deformable element 202 may include a spring element, such as, a coil spring, a leaf spring, a helical spring, and so on. It should be noted that a transition temperature of the SMM of the deformable element 202 may be selected or tuned based on a value of a predefined temperature threshold for the cell 102 (see FIG. 1). The term “predefined temperature threshold” as used herein may refer to a temperature beyond which the cell 102 may be susceptible to one or more adverse thermal events. In an example, the predefined temperature threshold may lie in a range of 85 to 110° C. The range of the predefined temperature threshold may vary, for example, based on an electrical capacity of the cell 102. In some cases, a material of the SMM may be chosen based on the predefined temperature threshold.

The deformable element 202 defines a first end 206 and a second end 208 distal to the first end 206. Further, in the illustrated embodiment of FIG. 2, the pre-stressed shape S1 of the deformable element 202 is bent partway along a length thereof and defines an included angle A1. When the deformable element 202 is in the pre-stressed shape S1, the deformable element 202 has a first portion 218 defining the first end 206 and a second portion 220 defining the second end 208. Thus, when the deformable element 202 is in the pre-stressed shape S1, the first portion 218 is angled or bent relative to the second portion 220, such that the deformable element 202 is substantially V-shaped. Alternatively, the deformable element 202 may be U-shaped or arcuate, for example. It should be noted that the pre-stressed shape S1 may have any other shape, based on specific requirements of an application. Further, when the deformable element 202 is in the pre-stressed shape S1, the first portion 218 has a length that is greater than a length of the second portion 220.

The sensor 200 also includes a coupling structure 204 to couple the sensor 200 to the outer surface 110 (see FIG. 1) of the housing 104 (see FIG. 1). In some examples, the coupling structure 204 may be made of a polymer or a metal to suit specific requirement of an application. The coupling structure 204 may be in the form of a plastic strip, for example. The first end 206 of the deformable element 202 is coupled to the coupling structure 204. Specifically, the first portion 218 of the deformable element 202 is coupled to the coupling structure 204. In an example, the first portion 218 of the deformable element 202 may be welded to the coupling structure 204. In other examples, the first portion 218 may be soldered, brazed, or coupled with the coupling structure 204 using any other coupling process known in the art.

In the illustrated embodiment of FIG. 2, the coupling structure 204 is C-shaped. However, in other embodiments, the coupling structure 204 may be V-shaped, arcuate, or have any other shape depending on specific requirement of an application. In one example, the sensor 200 may include an adhesive layer (not shown herein). The adhesive layer may be disposed on the coupling structure 204 to couple the sensor 200 to the outer surface 110 of the housing 104.

The sensor 200 further includes a metallic fuse element 210 coupled to the coupling structure 204 and the second end 208 of the deformable element 202. In an example, the fuse element 210 may be welded to the second portion 220 of the deformable element 202. In other examples, the fuse element 210 may be soldered, brazed, or coupled with the second portion 220 of the deformable element 202 using any other coupling process known in the art. Further, the fuse element 210 may be a thin strip, a thin wire, or a thin filament, made of, for example, tin, lead, silver, copper, zinc, or aluminum. The fuse element 210 may be made of an alloy including one of, for example, copper, zinc, lead, tin, silver, or aluminum.

The sensor 200 includes a first electrode 212 coupled to one end 226 of the fuse element 210. The sensor 200 also includes a second electrode 214 coupled to another end 228 of the fuse element 210. In some cases, each of the first electrode 212 and the second electrode 214 may be made of a metallic material, such as, copper or any other conductive material. In this context, the first and second electrodes 212, 214 allow connection of the fuse element 210 to a device, a circuit, or a controller for measuring an electrical resistance across the sensor 200. The first and second electrodes 212, 214 are connected to the fuse element 210 such that current is able to flow through the fuse element 210 from the first electrode 212 to the second electrode 214, or from the second electrode 214 to the first electrode 212. A current path is possible along the first electrode 212 through the fuse element 210 and the second electrode 214, or vice versa.

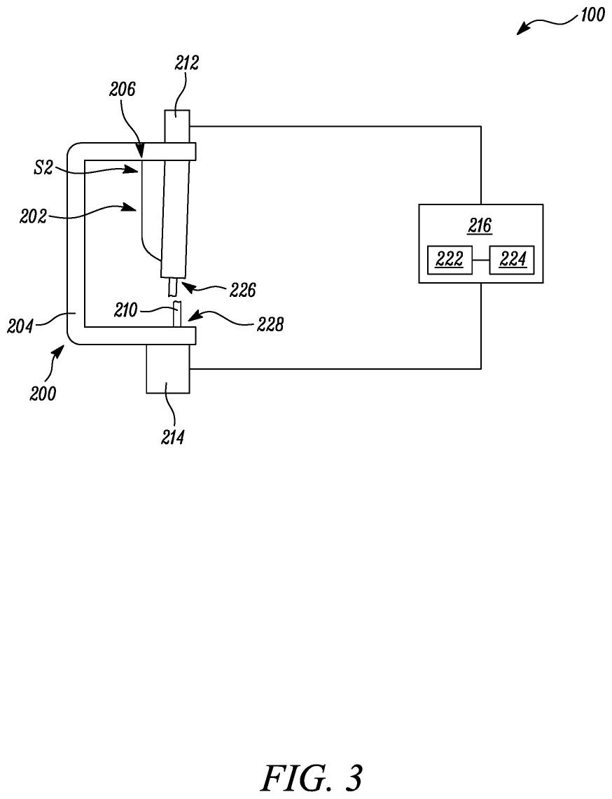

Referring now to FIG. 3, the deformable element 202 deforms to a memorized shape S2 from the pre-stressed shape S1 (see FIG. 2) in response to the operating temperature of the cell 102 (see FIG. 1) exceeding the predefined temperature threshold for the cell 102.

The memorized shape S2 of the deformable element 202 is different from the pre-stressed shape S1 of the deformable element 202. The memorized shape S2 may be linear or curvilinear. In the illustrated embodiment of FIG. 3, the memorized shape S2 is curvilinear. Alternatively, the memorized shape S2 may have any other shape, for example, the memorized shape S2 may be spiral or helical, based on application attributes.

The deformable element 202 breaks the fuse element 210 of the sensor 200 based on a deformity of the deformable element 202 to the memorized shape S2. In other words, the deformable element 202 may curl to the memorized shape S2 when the operating temperature of the cell 102 exceeds the predefined temperature threshold for the cell 102, thereby snapping the fuse element 210. The deformity of the deformable element 202 to the memorized shape S2 is indicative of the adverse thermal event in the cell 102. The adverse thermal event in the cell 102 is determined based on a visual inspection of the deformity of the deformable element 202 to the memorized shape S2. Specifically, the deformation of the deformable element 202 to the memorized shape S2 is triggered as a response as soon as the operating temperature of the cell 102 exceeds the predefined temperature threshold, and is therefore visually indicative of, the adverse thermal event. Thus, service technicians may determine if the cell 102 has experienced the adverse thermal event based on the visual inspection of the deformable element 202. Specifically, if the service technicians observe that the deformable element 202 has changed to the memorized shape S2, the personnel may conclude that the cell 102 has experienced at least one of the many types of adverse thermal events.

The battery system 100 further includes a controller 216. In an example, the controller 216 may determine occurrence of the adverse thermal event in the cell 102 based on breaking of the fuse element 210 of the sensor 200. Specifically, the first and second electrodes 212, 214 are in communication with the controller 216. The controller 216 measures an electrical resistance across the fuse element 210 of the sensor 200 to determine the adverse thermal event in the cell 102.

The controller 216 includes one or more memories 222 to store information pertaining to the predefined temperature threshold of the cell 102. The memories 222 may include any means of storing information, including a hard disk, an optical disk, a floppy disk, ROM (read only memory), RAM (random access memory), PROM (programmable ROM), EEPROM (electrically erasable PROM), or other computer-readable memory media.

The controller 216 also includes one or more processors 224 communicably coupled to the one or more memories 222. It should be noted that the one or more processors 224 may embody a single microprocessor or multiple microprocessors for receiving various input signals and generating output signals. Numerous commercially available microprocessors may perform the functions of the one or more processors 224. Each processor 224 may further include a general processor, a central processing unit, an application specific integrated circuit (ASIC), a digital signal processor, a field programmable gate array (FPGA), a digital circuit, an analog circuit, a microcontroller, any other type of processor, or any combination thereof. Each processor 224 may include one or more components that may be operable to execute computer executable instructions or computer code that may be stored and retrieved from the one or more memories 222.

Below the predefined temperature threshold, the electrical resistance across the fuse element 210 of the sensor 200 may have a predetermined threshold resistance. The predetermined threshold resistance may be stored in the memories 222 of the controller 216. In an event that the sensor 200 is heated above the predefined temperature threshold, the electrical resistance across the fuse element 210 of the sensor 200 changes. Specifically, the electrical resistance across the fuse element 210 changes when the fuse element 210 breaks due to a transition of the deformable element 202 to the memorized shape S2. Further, if the electrical resistance measured across the fuse element 210 is above the predetermined threshold resistance, the controller 216 determines that the adverse thermal event has occurred in the cell 102.

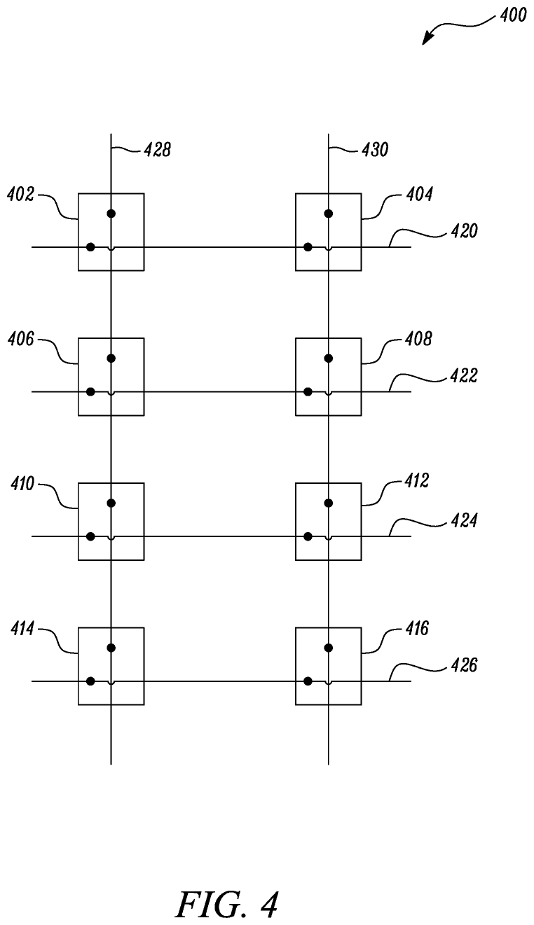

Referring now to FIG. 4, a schematic view of a battery system 400 is illustrated, according to an embodiment of the present disclosure. The battery system 400 is substantially similar to the battery system 100 illustrated in FIGS. 1 to 3, with common components being referred to by the same numerals. The battery system 400 has an array of sensors 402, 404, 406, 408, 410, 412, 414, 416 corresponding to a number of battery cells 102, each of which is same as the cell 102 shown and explained in relation to FIG. 1. Further, each sensor 402, 404, 406, 408, 410, 412, 414, 416, 418 is substantially similar in terms of construction, components, and functionality to the sensor 200 illustrated in FIGS. 1 to 3.

FIG. 4 shows the sensors 402, 404, 406, 408, 410, 412, 414, 416 arranged in an array of rows and columns, allowing each sensor 402, 404, 406, 408, 410, 412, 414, 416 to be addressed by row-column.

A first electrode (not shown herein) of the first (top) row of each sensor 402, 404 is connected to a first bus 420. A first electrode (not shown herein) of the second row of each sensor 406, 408 is connected to a second bus 422. A first electrode (not shown herein) of the third row of each sensor 410, 412 is connected to a third bus 424. A first electrode (not shown herein) of the fourth row of each sensor 414, 416 is connected to a fourth bus 426.

Further, a second electrode (not shown herein) of the first (left hand) column of each sensor 402, 406, 410, 414 is connected to a fifth bus 428. A second electrode (not shown herein) of the second column of each sensor 404, 408, 412, 416 is connected to a sixth bus 430. The point at which each sensor 402, 404, 406, 408, 410, 412, 414, 416 is connected to the respective bus 420, 422 424, 426, 428, 430 is shown by a dot. In this way, each sensor 402, 404, 406, 408, 410, 412, 414, 416 can be addressed individually to measure its electrical resistance. For example, the first bus 420 and the fifth bus 428 may be used to measure the electrical resistance of the sensor 402, and does not result in current flowing through other sensors 404, 406, 408, 410, 412, 414, 416.

The bus 420, 422 424, 426, 428, 430 may be connected to corresponding sensors 402, 404, 406, 408, 410, 412, 414, 416 such that the electrical resistance measurement is made in the plane of the sensors 402, 404, 406, 408, 410, 412, 414, 416, or such that the electrical resistance measurement is made through the sensors 402, 404, 406, 408, 410, 412, 414, 416, or in some other configuration.

The example illustrated in FIG. 4 shows eight sensors 402, 404, 406, 408, 410, 412, 414, 416 and six buses 420, 422 424, 426, 428, 430. Alternatively, the battery system 400 may include any number of sensors and buses, based on an electrical capacity of the battery system 400. Further, the sensors 402, 404, 406, 408, 410, 412, 414, 416 and the buses 420, 422 424, 426, 428, 430 may be arranged in a different configuration from that shown in FIG. 4. Any arrangement of the buses 420, 422 424, 426, 428, 430 that allows the electrical resistance of each sensor 402, 404, 406, 408, 410, 412, 414, 416 to be measured individually is possible.

Below the predefined temperature threshold, the electrical resistance across a fuse element (not shown) of a corresponding sensor 402, 404, 406, 408, 410, 412, 414, 416 may have a predetermined threshold resistance. In an event wherein one or more of the sensors 402, 404, 406, 408, 410, 412, 414, 416 are heated to above the predefined temperature threshold, the electrical resistance across the fuse element of the corresponding sensor 402, 404, 406, 408, 410, 412, 414, 416 changes. Further, the controller 216 (see FIG. 3) is in communication with each of the buses 420, 422 424, 426, 428, 430. In an event that the measured electrical resistance across the fuse element of one or more sensors 402, 404, 406, 408, 410, 412, 414, 416 is above the predetermined threshold resistance, the controller 216 determines that an adverse thermal event has occurred in the cell 102 of the corresponding sensor 402, 404, 406, 408, 410, 412, 414, 416.

In an example wherein the controller 216 determines that the adverse thermal event has occurred in one or more of the battery cells 102, a notification may be provided to a user of the battery system 400. The notification may be sent to a user interface (not shown), and may include an electronic message or a wireless message, turning-on of a light or buzzer, or any other notification. The notification may be visual, audible, electronic, wireless, or otherwise.

It is to be understood that individual features shown or described for one embodiment may be combined with individual features shown or described for another embodiment. The above described implementation does not in any way limit the scope of the present disclosure. Therefore, it is to be understood although some features are shown or described to illustrate the use of the present disclosure in the context of functional segments, such features may be omitted from the scope of the present disclosure without departing from the spirit of the present disclosure as defined in the appended claims.

### Industrial Applicability

The present disclosure describes the battery system 100, 400 including the sensor 200, 402, 404, 406, 408, 410, 412, 414, 416 to determine the adverse thermal event in the cell 102. As described above, the sensor 200 includes the deformable element 202 that deforms to the memorized shape S2 from the pre-stressed shape S1 in response to the operating temperature of the cell 102 exceeding the predefined temperature threshold for the cell 102.

In this manner, it would be possible for service technicians to identify and locate battery cells 102 in which the operating temperature has exceeded the predefined temperature threshold. For example, the sensor 200, 402, 404, 406, 408, 410, 412, 414, 416 may be used to determine whether one or more battery cells 102 have exceeded the operating temperature at which a separator is configured to disable the cell 102, so that any disabled cell 102 may be removed and replaced. In an example, the sensor 200, 402, 404, 406, 408, 410, 412, 414, 416 may be used to determine whether the cell 102 has exceeded the predefined temperature threshold at which issues, such as, thermal runaway are known to arise. This may allow timely replacement of the cell 102.

In an example, the sensor 200, 402, 404, 406, 408, 410, 412, 414, 416 may be visually inspected to determine the adverse thermal event in the cell 102. In another example, the controller 216 may be used to measure the electrical resistance across the one or more sensors 200, 402, 404, 406, 408, 410, 412, 414, 416 to determine the adverse thermal event in the cell 102. In some examples, the electrical resistance may be measured by the controller 216 in a sequential manner to identify failed or disabled cells 102. Incorporation of the sensor 200, 402, 404, 406, 408, 410, 412, 414, 416 may improve safety of the cell 102 and may also reduce the time required to determine adverse thermal events, especially in battery systems that include multiple battery cells arranged in a parallel configuration.

The sensor 200, 402, 404, 406, 408, 410, 412, 414, 416 may be cost-effective and may be retrofitted in existing battery systems. The sensor 200, 402, 404, 406, 408, 410, 412, 414, 416 may be simple in construction and may embody a compact sticker that can be easily affixed to the housing 104 of the cell 102.

The sensor 200, 402, 404, 406, 408, 410, 412, 414, 416 may improve battery management system estimation of the battery system 100, 400. For example, the sensor 200 may allow a more accurate estimation of various parameters associated with the cell 102 by analyzing the battery cell-level information such as voltage, temperature and current. Further, the sensor 200, 402, 404, 406, 408, 410, 412, 414, 416 may improve reliability and serviceability of the cell 102 by aiding in determining the failure of one or more battery cells 102.

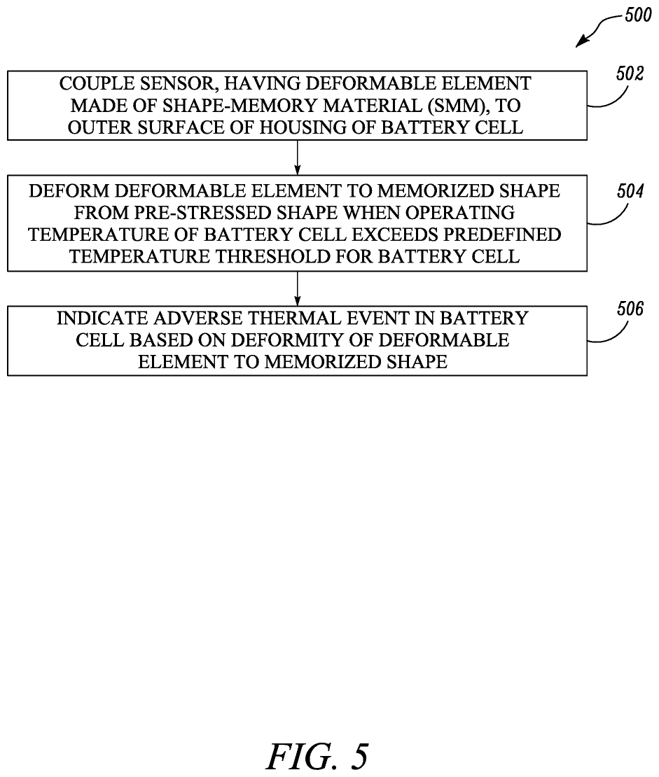

Referring to FIG. 5, a method 500 for determining the adverse thermal event in the cell 102 is illustrated. With reference to FIGS. 1 to 3 and FIG. 5, at step 502, the sensor 200 including the deformable element 202 made of the shape-memory material (SMM) is coupled to the outer surface 110 of the housing 104 of the cell 102. The deformable element 202 has the pre-stressed shape S1.

At step 504, the deformable element 202 is deformed to the memorized shape S2 from the pre-stressed shape S1 when the operating temperature of the cell 102 exceeds the predefined temperature threshold for the cell 102. The memorized shape S2 of the deformable element 202 is different from the pre-stressed shape S1 of the deformable element 202. At step 506, the adverse thermal event in the cell 102 is indicated based on the deformity of the deformable element 202 to the memorized shape S2.

The method 500 further includes a step (not shown) of determining the adverse thermal event in the cell 102 based on the visual inspection of the deformity of the deformable element 202 to the memorized shape S2.

The method 500 further includes a step (not shown) of coupling the sensor 200 to the outer surface 110 of the housing 104 using the coupling structure 204 of the sensor 200. The first end 206 of the deformable element 202 is coupled to the coupling structure 204.

The method 500 further includes a step (not shown) of breaking, by the deformable element 202, a metallic fuse element 210 of the sensor 200 based on the deformity of the deformable element 202 to the memorized shape S2. The fuse element 210 is coupled to the coupling structure 204 and the second end 208 of the deformable element 202.

The method 500 also includes a step (not shown) of communicably coupling the first and second electrodes 212, 214 of the sensor 200 with the controller 216. The first electrode 212 is coupled to one end 226 of the fuse element 210 of the sensor 200 and the second electrode 214 is coupled to another end 228 of the fuse element 210. The method 500 further includes a step (not shown) of measuring, by the controller 216, the electrical resistance across the fuse element 210 of the sensor 200 to determine the adverse thermal event in the cell 102.

While aspects of the present disclosure have been particularly shown and described with reference to the embodiments above, it will be understood by those skilled in the art that various additional embodiments may be contemplated by the modification of the disclosed work machine, systems and methods without departing from the spirit and scope of the disclosure. Such embodiments should be understood to fall within the scope of the present disclosure as determined based upon the claims and any equivalents thereof.

What is claimed is:

1. A battery system comprising:
a battery cell including a housing, the housing including a plurality of walls that define an outer surface of the housing; and
a sensor coupled to the outer surface of the housing and configured to determine an adverse thermal event in the battery cell, wherein:
the sensor includes a deformable element made of a shape-memory material (SMM) and has a pre-stressed shape,
the deformable element is adapted to deform to a memorized shape from the pre-stressed shape in response to an operating temperature of the battery cell exceeding a predefined temperature threshold for the battery cell,
the memorized shape of the deformable element is different from the pre-stressed shape of the deformable element, and
a deformity of the deformable element to the memorized shape is indicative of the adverse thermal event in the battery cell.

2. The battery system of claim 1, wherein the adverse thermal event in the battery cell is determined based on a visual inspection of the deformity of the deformable element to the memorized shape.

3. The battery system of claim 1, wherein the pre-stressed shape of the deformable element is bent partway along a length thereof and defines an included angle.

4. The battery system of claim 1, wherein the memorized shape is linear or curvilinear.

5. The battery system of claim 1, wherein the sensor includes:
a coupling structure to couple the sensor to the outer surface of the housing, wherein a first end of the deformable element is coupled to the coupling structure;
a metallic fuse element coupled to the coupling structure and a second end of the deformable element;
a first electrode coupled to one end of the fuse element; and
a second electrode coupled to another end of the fuse element.

6. The battery system of claim 5, wherein the deformable element is adapted to break the fuse element of the sensor based on the deformity of the deformable element to the memorized shape.

7. The battery system of claim 5 further comprising a controller, wherein the first and second electrodes are in communication with the controller, and wherein the controller is configured to measure an electrical resistance across the fuse element of the sensor to determine the adverse thermal event in the battery cell.

8. The battery system of claim 1, wherein the SMM of the deformable element is a shape-memory alloy (SMA).

9. The battery system of claim 1, wherein the adverse thermal event in the battery cell includes one of an overheating event, a fire originating from the battery cell, and a thermal runaway event.

10. A sensor for determining an adverse thermal event in a battery cell, the sensor comprising:
a deformable element made of a shape-memory material (SMM) and has a pre-stressed shape, wherein:
the deformable element is adapted to deform to a memorized shape from the pre-stressed shape in response to an operating temperature of the battery cell exceeding a predefined temperature threshold for the battery cell,
the memorized shape of the deformable element is different from the pre-stressed shape of the deformable element, and
a deformity of the deformable element to the memorized shape is indicative of the adverse thermal event in the battery cell.

11. The sensor of claim 10, wherein the adverse thermal event in the battery cell is determined based on a visual inspection of the deformity of the deformable element to the memorized shape.

12. The sensor of claim 10, wherein the pre-stressed shape of the deformable element is bent partway along a length thereof and defines an included angle, and wherein the memorized shape is linear or curvilinear.

13. The sensor of claim 10 further comprising:
a coupling structure to couple the sensor to an outer surface of a housing of the battery cell, wherein a first end of the deformable element is coupled to the coupling structure;
a metallic fuse element coupled to the coupling structure and a second end of the deformable element;
a first electrode coupled to one end of the fuse element; and
a second electrode coupled to another end of the fuse element.

14. The sensor of claim 13, wherein the deformable element is adapted to break the fuse element of the sensor based on the deformity of the deformable element to the memorized shape.

15. The sensor of claim 13, wherein the first and second electrodes are in communication with a controller, and wherein the controller is configured to measure an electrical resistance across the fuse element of the sensor to determine the adverse thermal event in the battery cell.

16. A method for determining an adverse thermal event in a battery cell, the method comprising:
coupling a sensor, including a deformable element made of a shape-memory material (SMM), to an outer surface of a housing of the battery cell, wherein the deformable element has a pre-stressed shape;
deforming the deformable element to a memorized shape from the pre-stressed shape when an operating temperature of the battery cell exceeds a predefined temperature threshold for the battery cell, wherein the memorized shape of the deformable element is different from the pre-stressed shape of the deformable element; and
indicating the adverse thermal event in the battery cell based on a deformity of the deformable element to the memorized shape.

17. The method of claim 16 further comprising determining the adverse thermal event in the battery cell based on a visual inspection of the deformity of the deformable element to the memorized shape.

18. The method of claim 16 further comprising:
coupling the sensor to the outer surface of the housing using a coupling structure of the sensor, wherein a first end of the deformable element is coupled to the coupling structure.

19. The method of claim 18 further comprising:
breaking, by the deformable element, a metallic fuse element of the sensor based on the deformity of the deformable element to the memorized shape, wherein the fuse element is coupled to the coupling structure and a second end of the deformable element.

20. The method of claim 19 further comprising:
communicably coupling, the first and second electrodes of the sensor with a controller, wherein the first electrode is coupled to one end of the fuse element of the sensor and the second electrode is coupled to another end of the fuse element; and
measuring, by the controller, an electrical resistance across the fuse element of the sensor to determine the adverse thermal event in the battery cell.
